(19) United States
(12) Patent Application Publication
(10) Pub. No.: US 2007/0029235 A1
(43) Pub. Date: Feb. 8, 2007

(54) Metal separator

(76) Inventor: Helmuth Frisch, Schonberg (DE)

Correspondence Address: FAY KAPLUN & MARCIN, LLP, 15O BROADWAY, SUITE 702, NEW YORK, NY, 10038, US

(21) Appl. No.: 11/500,076

(22) Filed: Aug. 7, 2006

(30) Foreign Application Priority Data
Aug. 8, 2005 (DE) 20 2005 012 644.6

(51) Int. Cl. B01D 35/00

(52) U.S. Cl. 210/85; 73/61.42; 210/243; 204/600; 422/68.1

(57) ABSTRACT

A metal separator for separating metallic parts in a material flow formed by part icles is described. The material flow passing vertically through the metal separator from a top of the metal separator. The metal separator may include (i) a separation module holding a separation unit; and (ii) a detection module including a metal detection element which is detachably connected to the separation module. The separation module is arranged vertically below the detection module.

### FIELD OF INVENTION

The present invention relates to metal separators with which it is possible to remove metallic parts from material flows formed by particles. Such material flows can be formed by a very wide variety of non-metallic particles which are to subsequently undergo mechanical processing. Said particles can be different plastics which, for example, are fed as granules to an extruder or an injection-molding machine. Cereal grains can however also be fed through a metal separator of said type in order to protect mill tools from damage on account of metal parts.

### BACKGROUND INFORMATION

Metal detection elements, for example induction coils, are conventionally included in metal separators, said metal detection elements providing signals for controlling elements for separating metal parts from the material flow. Here, a metal-containing portion of the material flow is often deflected such that it is led away via a separation channel and is, in a way, discharged. It can thus be ensured that particles which are free of metal are supplied for further processing.

It is however also possible to remove only a portion of the material flow in which metal parts are detected. In this case, the use of venturi nozzles is known, for example, from DE 29507 979.

For the purpose of separation, however, it is also possible for flaps to be pivoted or for pushers to be displaced in order to deflect the material flow when metal is detected, as is described in DE 296 19 173.

The known solutions have the disadvantage that they cannot be directly adapted to different local conditions or to different material flows, and a new modification of a metal separator is required for the respective demands.

### SUMMARY OF THE INVENTION

The metal separator according to an exemplary embodiment of the present invention has two modules which can be detachably connected to one another. Here, at least one metal detection element, which is known per se and by means of which metal parts in the material flow can be detected, is held in a detection module.

The second module is embodied as a separation module and holds a separation unit which can likewise be embodied in a form known per se.

The separation module is then fastened to the bottom of the detection module so that said two parts then form the metal separator through which the respective material flow passes for the purpose of detection and separation.

In a corresponding embodiment, differently-configured detection and separation modules can also be combined with one another as required. In some cases, it is then only necessary to adapt the electronic controller in order to also be able to adapt the measured detection signals to the respective separation unit for the purpose of activating the latter.

The electronic controller can be attached in or can be integrated into one of the two modules.

Since a separation channel which leads outwards is conventionally provided for discharging metal parts alone or a part of the material flow in which metal has been detected, the inventive embodiment of the metal separator having the two individual modules has t he advantageous effect that the angular alignment of a separation channel can be set to local conditions by means of a corresponding angular alignment of the two modules relative to one another, and that the two modules can be fastened to one another and locked in said angular alignment.

It is particularly advantageous to connect the detection module and the separation module to one another by means of at least one adaptor element. The material flow can then be guided through the two modules and the at least one adaptor element.

It is additionally possible, by means of adaptor elements which are hollow on the inside, to lengthen the path which the material flow covers between the metal detection element and the separation unit. Stipulated requirements can be correspondingly taken into consideration by means of the respective length of an adaptor element or of a plurality of adaptor elements which are connected to one another.

Adaptor elements are preferably tubular, that is to say rotationally symmetrical, so that simple angular alignment of the two modules relative to one another, as explained previously, is possible.

The distance which the particles fall between the metal detection element and the separation unit can also, however, be varied, and set to a predefineable length, by means of telescopic adaptor elements.

The modules and/or one or more adaptor elements can preferably be detachably connected in a form-fitting and/or force-fitting manner. Here, suitably-shaped flanges can be arranged on the underside of a detection module and/or on the top of a separation module. Flanges of said type can be designed and dimensioned such that the modules are connected to one another or also to one or more adaptor elements.

Quick-action clamping locks can advantageously be provided on modules and/or adaptor element(s).

### BRIEF DESCRIPTION FOR DRAWINGS

The present invention is explained in more detail in the following on the basis of exemplary embodiments.

In the figures:

FIG. 1 shows an exemplary embodiment of a metal separator according to the present invention and

FIG. 2 shows a further exemplary embodiment of a metal separator according to the present invention.

### DETAILED DESCRIPTION

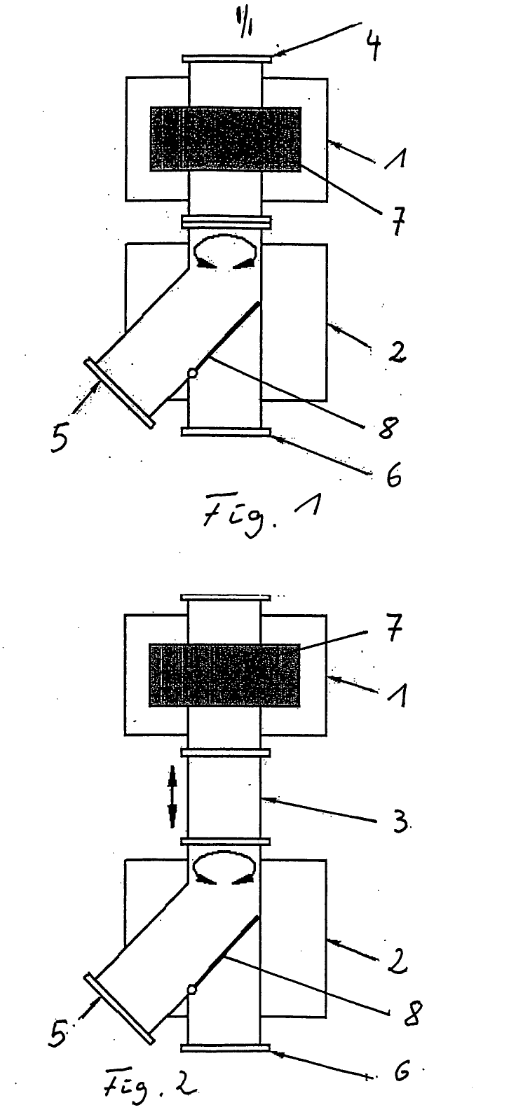

In the exemplary embodiment shown in FIG. 1, a detection module 1 and a separation module 2 are connected to one another. Here, both modules 1 and 2 can be rotated relative to one another into a desired angular alignment relative to one another, as indicated by the arrow.

In this way, it is possible to set a desired alignment of a separation channel 5 via which material flow containing metal parts can be discharged and separated from the metal-free material flow.

The material flow enters into the metal separator vertically from the top via the inlet 4 and usually falls through said metal separator from top to bottom.

If metal which is contained in the material flow is detected by means of at least one metal detection element 7, for example an induction coil, a separation unit 8, in this case a pivotable flap, is activated by means of an electronic controller (not illustrated here). The flap is pivoted such that the goods outlet 6 is blocked and the material flow containing metal is discharged via the separation channel 5.

After a sufficient length of time, the flap is pivoted back and the separation channel 5 is blocked and the goods outlet 6 for the material flow is unblocked.

The connecting flanges 9 of the detection module 1 and of the separation module 2 are designed so as to provide a secure connection with the capability of rotation relative to one another and as far as possible the capability of being locked in a desired angular alignment relative to one another.

Significant points of the example shown in FIG. 2 correspond to the inventive example according to FIG. 1. Between the detection module 1 and the separation module 2, a tubular adaptor element 3 is additionally connected to both modules 1 and 2.

The in this case one adaptor element 3 lengthens the path which the material flow free-falls between the detection element 7 and the separation unit 8.

Said path can be influenced in a targeted fashion by means of predefineable lengths of adaptor elements 3. The same effect can be obtained by means of telescopic adaptor elements 3. The possibility of such a change is indicated by the double arrow at the adaptor element 3.

1. A metal separator for separating metallic parts in a material flow formed by particles, the material flow passing vertically through the metal separator from a top of the metal separator, the metal separator comprising:
a separation module holding a separation unit;
a detection module including a metal detection element which is detachably connected to the separation module, the separation module being arranged vertically below the detection module.

2. The metal separator according to claim 1, further comprising:
at least one adaptor element connecting the detection module and the separation module.

3. The metal separator according to claim 2, wherein an inside of the at least one adaptor element is hollow.

4. The metal separator according to claim 2, wherein the at least one adaptor element has a tubular shape.

5. The metal separator according to claim 2, wherein the at least one adaptor element has a predefined length.

6. The metal separator according to claim 2, wherein the at least one adaptor element is interchangeable.

7. The metal separator according to claim 2, wherein the at least one adaptor element is telescopic.

8. The metal separator according to claim 2, wherein the at least one adaptor element includes a first adaptor element and a second adaptor element, the first and second adaptor elements being connected to one another.

9. The metal separator according to claim 1, wherein the detection module and the separation module are rotatable relative to one another and are capable of being locked in an angular alignment relative to one another.

10. The metal separator according to claim 2, wherein at least two of the detection module, the separation module and the at least one adaptor element are connected to one another in at least one of (i) a form-fitting manner and (ii) a force-fitting manner.

11. The metal separator according to claim 2, further comprising:
quick-action clamping locks being attached to at least one of the detection module, the separation module and the at least one adaptor element.
